(19) United States
(12) Patent Application Publication
(10) Pub. No.: US 2010/0323634 A1
(43) Pub. Date: Dec. 23, 2010

(54) SEMICONDUCTOR DEVICE AND SIGNAL PROCESSING METHOD THEREOF

(76) Inventor: Tohru Kimura, Tokyo (JP)

Correspondence Address: Mr. Jackson Chen, 6535 N. STATE HWY 161, IRVING, TX, 75039, US

(21) Appl. No.: 12/526,342

(22) PCT Filed: Jan. 4, 2008
(86) PCT No.: PCT/JP2008/050006

§ 371 Date: Aug. 7, 2009

(30) Foreign Application Priority Data
Mar. 19, 2007 (JP) 2007-070580

(51) Int. Cl. H04B 7/24

(52) U.S. Cl. 455/68; 455/39

(57) ABSTRACT

Disclosed is a semiconductor device for performing wireless communication, including a wireless transmitting and receiving unit that transmits and receives a wireless signal, and an external interface unit that transmits and receives a signal to and from an external apparatus connected to the semiconductor device at a signal voltage larger than that of the wireless signal transmitted and received by the wireless transmitting and receiving unit. The wireless transmitting and receiving unit and the external interface unit mutually operate in a time-exclusive way.

### TECHNICAL FIELD

The present invention relates to a semiconductor device that transmits and receives a signal to and from an external apparatus, and a signal processing method thereof, and more particularly, to a semiconductor device that transmits and receives a wireless signal, and a signal processing method thereof.

### BACKGROUND ART

With recent improvements of a semiconductor microfabrication technology, a semiconductor device has been stably supplied at low prices in large quantities and is widely used into daily life. Particularly, with recent improvements of a wireless communication technology, a wireless communication device used for wireless communication has been developed. Therefore, the advent of a ubiquitous era in which wireless communication devices will be incorporated into everything is anticipated. Because, in this ubiquitous era, the number of wireless communication devices will have to match the number of articles used by people, these devices essentially will have to be provided at a low cost and will have to consume low power.

A wireless communication device of a mechanism that configures a network between a plurality of wireless communication devices and that sends data acquired by the respective wireless communication devices to a server (PAN coordinator) has been considered as such a wireless communication device (e.g. refer to IEEE Computer Society, 804. 15.4, Part 15.4: Wireless Medium Access Control (MAC) and Physical Layer (PHY) Specifications for Low-Rate Wireless Personal Area Networks (LR-WPANs)). In order to implement the wireless communication device of such a network at low prices with low power, it is effective to implement a device (System on Chip mounted Radio Frequency circuit; RF SoC), wherein a wireless transmitting and receiving circuit (hereinafter, referred to as ‘RF circuit’) that transmits and receives a wireless signal, an analog circuit that processes an analog signal, a digital circuit that processes a digital signal, and an external interface circuit having an interface function with an external apparatus are mounted on one chip. Presently, research and development have been conducted for such implementation.

The RF SoC deals with signals having a few kinds of voltages and amplitudes in the chip. An RF receiving circuit unit that amplifies a received wireless signal having the lowest amplitude and having the power of a few μV (microvolt), extracts an analog signal from a carrier wave contained in the wireless signal, and amplifies the analog signal into a few mV, an analog-digital conversion circuit unit (hereinafter, referred to as ‘AD’ unit) that converts the analog signal amplified into a few mV by the RF receiving circuit unit into a digital signal of about 1 V, a digital signal processing circuit unit (hereinafter, referred to as ‘digital circuit unit’) that judges whether the digital signal converted by the AD unit is regular data to be received via matching/non-matching confirmation of a transmitting and receiving node address and authentication, and performs signal processing for restoring the transmitted signal, a memory circuit unit that memorizes various signals, and an external interface circuit unit (hereinafter, referred to as ‘IF circuit unit’) that transmits the restored signal from the RF SoC to the external apparatus are arranged in a circuit portion on the wireless signal receiving side in the RF Soc.

In the same manner, an IF circuit unit, a memory circuit unit, a digital circuit unit, a digital-analog conversion circuit unit (hereinafter, referred to as ‘DA unit’), and an RF transmitting circuit unit are arranged in a circuit portion on the wireless signal transmitting side, such that a digital signal is generated by attaching transmission and reception information, such as a transmitting source, a transmitting destination and a final reaching destination, an authentication ID, an error check index, etc., to a signal input to the IF circuit unit, converted into an analog signal through the DA unit, and transmitted as a wireless signal via a carrier wave by the RF transmitting circuit unit.

Accordingly, the RF receiving circuit unit handling a low amplitude low power signal of a few μV and the IF circuit unit handling a signal of a few V are mounted in the same chip.

FIG. 1 is a diagram illustrating one example of an internal circuit layout of a conventional RF SoC.

IF circuit unit 901, RF circuit unit 902, analog circuit unit 903, digital circuit unit 904, memory circuit unit 905 and PAD 906 for a connection terminal are laid out in the RF SoC of FIG. 1.

IF circuit unit 901 is an external interface circuit unit that generates and transmits a signal connected to an external apparatus, and receives and interprets the same. RF circuit unit 902 is a wireless transmitting and receiving circuit unit composed of RF receiving circuit unit 921 that is a receiving unit receiving a wireless signal, and RF transmitting circuit unit 922 that is a transmitting unit transmitting a wireless signal. Analog circuit unit 903 is composed of AD unit 931 that converts an analog signal into a digital signal, and DA unit 932 that converts a digital signal into an analog signal. Digital circuit unit 904 performs address matching/non-matching confirmation or authentication of a received signal, and generates and attaches such data to a transmitted signal. Memory circuit unit 905 sustains intermediate data.

To obtain a common potential (hereinafter, referred to as ‘Vcom’) is important between RF SoC internal circuits, e.g. in processing of RF circuit unit 902 and analog signal processing of analog circuit unit 903. This is because transmitted and received data are expressed by an analog voltage between the circuits. If Vcom is different between the respective circuits, it leads to loss or damage of the transmitted and received data.

Meanwhile, IF circuit unit 901 should drive load of a few to a few tens pF by a logic amplitude of a few V, and operates at a much larger voltage and current than RF circuit unit 902. When IF circuit unit 901 operates, a large current flows in and out at Vcom potential and GND potential, which affects the operation of RF circuit unit 902. Such an effect is manifested as operation noise of RE circuit unit 902, thereby deteriorating a signal/noise ratio (hereinafter, referred to as ‘S/N ratio’) of the received wireless signal. Sometimes, this effect may lead to non-reception.

In order to prevent this effect, some RF SoC devices secure a separation region that blocks noise infiltration from a peripheral circuit unit around RF circuit unit 902, to thereby remove the detrimental effect on a wireless receiving operation.

FIG. 2 is a diagram illustrating one example of an internal circuit layout of a conventional RF SoC where a separation region is secured.

In the RF SoC of FIG. 2, separation region 907 is arranged around RF circuit unit 902 and analog circuit unit 903 of the RF SoC of FIG. 1.

Moreover, considered is a device, wherein a transmitting circuit that transmits a signal and a receiving circuit that receives a signal are laid out as island regions separated from each other by an insulator, such that the transmitting circuit and the receiving circuit are not affected by each other's signal (e.g. refer to Japanese Laid-Open Patent Publication No. 2005-167536).

Further, considered is a device, wherein a first module formed of a digital circuit and a second module formed of an analog circuit operate in a time-exclusive way (e.g. refer to Japanese Laid-Open Patent Publication No. 1996-329035).

However, the above-described prior arts have a few problems.

As a first problem, the separation region arranged to protect the RF circuit unit from operation noise of another circuit unit increases a chip area of the RF SoC, which leads to increased cost and power consumption.

As a second problem, the separation region cannot eliminate the entire operation noise applied to the RF circuit unit. Since the RF SoC is formed of a semiconductor, separation using (1) a high resistance and (2) a large capacity is generally used for electrical separation of circuit blocks. However, the more the electrical separation between the circuit blocks is planned, the more it becomes difficult to sustain the same Vcom potential between the respective circuit blocks. When the impedance of Vcom potential commonly used between the circuit blocks is increased, Vcom potential between the respective circuit blocks becomes different. Therefore, the electrical separation can be planned merely to an extent to restrict a difference of Vcom potentials to within a range to be ignored in terms of a circuit operation.

Also, in the device disclosed in Japanese Laid-Open Patent Publication No. 2005-167536, the transmitting circuit and the receiving circuit should be arranged as island regions that are separated from each other by the insulator, which increases the area that is needed.

In addition, the device disclosed in Japanese Laid-Open Patent Publication No. 1996-329035 merely controls operations of the digital circuit and the analog circuit in a time-exclusive way.

### DISCLOSURE

### Technical Problem

An object of the present invention for solving the foregoing problems is to provide a semiconductor device that can easily receive a wireless signal having a good S/N ratio, and a signal processing method thereof.

### Technical Solution

In order to accomplish the above object, there is provided a semiconductor device for performing wireless communication, including: a wireless transmitting and receiving unit that transmits and receives a wireless signal; and an external interface unit that transmits and receives a signal to and from an external apparatus connected to the semiconductor device at a signal voltage larger than that of the wireless signal transmitted and received by the wireless transmitting and receiving unit, wherein the wireless transmitting and receiving unit and the external interface unit mutually operate in a time-exclusive way.

In addition, there is provided a signal processing method of a semiconductor device including a wireless transmitting and receiving unit that transmits and receives a wireless signal, and an external interface unit that transmits and receives a signal at a signal voltage larger than that of the wireless signal transmitted and received by the wireless transmitting and receiving unit, the method including controlling an operation of the wireless transmitting and receiving unit and an operation of the external interface unit in a time-exclusive way.

### ADVANTAGEOUS EFFECTS

As explained above, according to the present invention, the wireless transmitting and receiving unit transmits and receives a wireless signal, the external interface unit transmits and receives a signal to and from the external apparatus connected to the semiconductor device at a signal voltage larger than that of the wireless signal transmitted and received by the wireless transmitting and receiving unit, and the wireless transmitting and receiving unit and the external interface unit mutually operate in a time-exclusive way, so that it is possible to easily receive a wireless signal having a good S/N ratio.

### DESCRIPTION OF DRAWINGS

FIG. 1 is a diagram illustrating one example of an internal circuit layout of a conventional RF SoC;

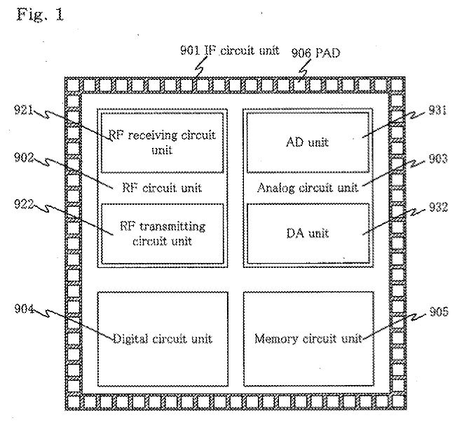

FIG. 2 is a diagram illustrating one example of an internal circuit layout of a conventional RF SoC where a separation region is secured;

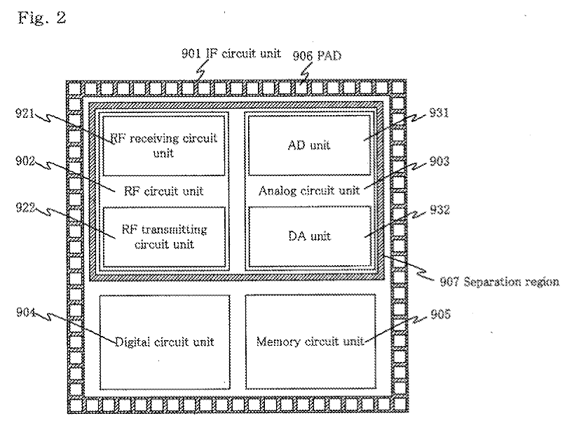

FIG. 3 is a diagram illustrating an exemplary embodiment of an RF SoC that is a semiconductor device of the present invention;

FIG. 4 is a diagram illustrating a construction of the RF SoC of FIG. 3;

FIG. 5 is a diagram illustrating one example of an internal circuit layout of the RF SoC of FIG. 3;

FIG. 6 is a graph showing the relation between consumed power and time in a sensor network node of FIG. 3;

FIG. 7 is a diagram illustrating a construction of an RF SoC in which a buffer that preserves a transmitted and received signal is arranged;

FIG. 8 is a diagram illustrating a communication protocol used generally in wireless communication;

FIG. 9 is a view illustrating a new detailed circuit construction of the RF SoC of FIG. 4; and

FIG. 10 is a view illustrating a configuration of a wireless communication sensor network system using the sensor network node of FIG. 3.

### MODE FOR INVENTION

Hereinafter, exemplary embodiments of the present invention will be explained with reference to the drawings.

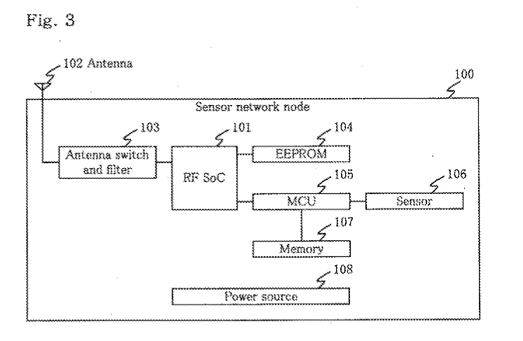

FIG. 3 is a diagram illustrating an exemplary embodiment of an RF SoC that is a semiconductor device of the present invention.

In this exemplary embodiment, as shown in FIG. 3, RF SoC 101 is applied to sensor network node 100 composed of RF SoC 101, antenna 102, antenna switch and filter 103, EEPROM 104, MCU 105, sensor 106, memory 107 and power source 108.

RF SoC 101 is a System on Chip (SoC) with a wireless communication circuit that is a semiconductor device of the present invention mounted thereon.

Antenna 102 transmits and receives a wireless signal to and from an apparatus connected to sensor network node 100 by wireless.

Antenna switch and filter 103 selects a signal transmitted from antenna 102 and a signal received by antenna 102. In addition, antenna switch and filter 103 erase a certain frequency element from the wireless signal transmitted and received by antenna 102.

EEPROM 104 memorizes an address, communication channel, ID code for authentication, etc. of sensor network node 100.

MCU 105 controls data recording on memory 107 and data reading from memory 107.

Sensor 106 measures a surrounding environment (temperature or humidity, etc.) where sensor network node 100 has been installed.

Memory 107 memorizes information measured by sensor 106.

Power source 108 supplies power to the respective circuit units constituting sensor network node 100.

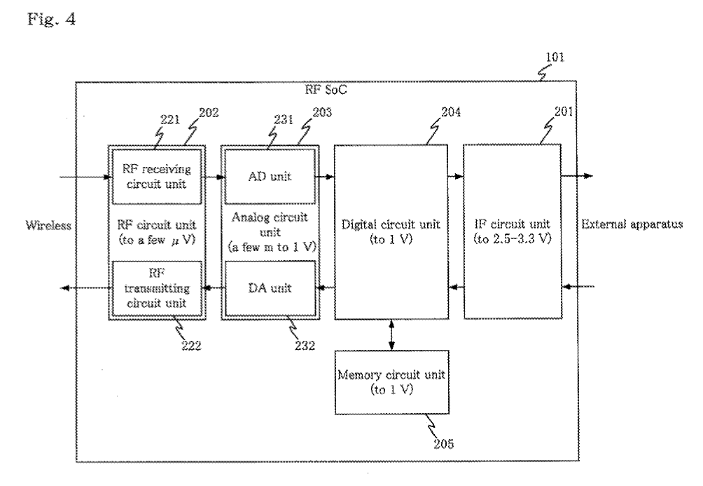

FIG. 4 is a diagram illustrating a construction of the RF SoC of FIG. 3.

As illustrated in FIG. 4, IF circuit unit 201, RF circuit unit 202, analog circuit unit 203, digital circuit unit 204 and memory circuit unit 205 are arranged in RF SoC 101 of FIG. 3.

Moreover, RF circuit unit 202 is composed of RF receiving circuit unit 221 and RF transmitting circuit unit 222. Further, analog circuit unit 203 is composed of AD unit 231 and DA unit 232.

IF circuit unit 201 generates and transmits, and receives and interprets a signal transmitted and received to and from an external apparatus connected to RF SoC 101.

RF receiving circuit unit 221 is a receiving unit that receives a wireless signal.

RF transmitting circuit unit 222 is a transmitting unit that transmits a wireless signal.

AD unit 231 converts an analog signal received by RF receiving circuit unit 221 into a digital signal.

DA unit 232 converts a digital signal processed by digital circuit unit 204 into an analog signal.

Digital circuit unit 204 performs address matching/non-matching confirmation or authentication of a received signal from a wireless section, and generates and attaches such data to a transmitted signal to the wireless section.

Memory circuit unit 205 sustains intermediate data.

In addition, the respective circuit units of FIG. 4 operate at signal amplitudes shown in the drawing. These signal amplitudes will be described later.

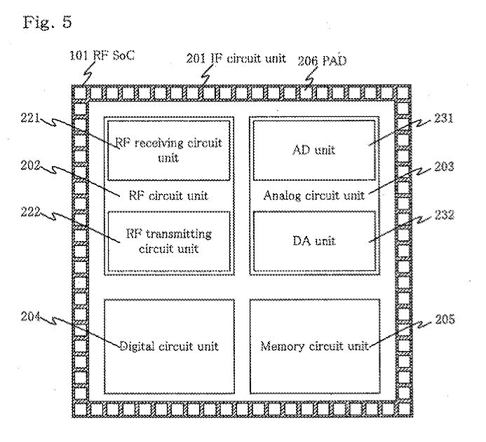

FIG. 5 is a diagram illustrating one example of an internal circuit layout of RF SoC 101 of FIG. 3.

As illustrated in FIG. 5, IF circuit unit 201, RF circuit unit 202, analog circuit unit 203, digital circuit unit 204, memory circuit unit 205 and PAD 206 for a connection terminal are laid out in RF SoC 101 of FIG. 3. Moreover, RF receiving circuit unit 221 and RF transmitting circuit unit 222 are laid out in RF circuit unit 202. Further, AD unit 231 and DA unit 232 are laid out in analog circuit unit 203. Operations of the respective laid-out circuit units of FIG. 5 are same as those explained above.

Hereinafter, a signal processing method in the above-described exemplary embodiment will be described.

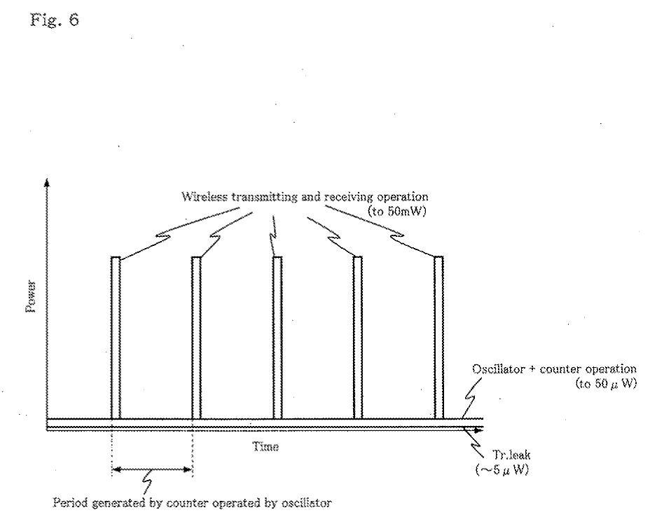

FIG. 6 is a graph showing the relation between consumed power and time in sensor network node 100 of FIG. 3.

As soon as power 108 is input, sensor network node 100 of FIG. 3 reads a node address, communication channel setting, ID code for authentication, etc. from external EEPROM 104, and enters into a receiving standby state. After RF SoC 101 is in the receiving standby state, as shown in FIG. 6, time is clocked by a counter and an oscillator installed in sensor network node 100, and a wireless transmitting and receiving operation is intermittently performed at preset periods. Power consumed for the wireless transmitting and receiving operation is about 50 mW. Also, power consumed for operations of the counter and the oscillator has a much smaller value than power consumed for the wireless transmitting and receiving operation.

In addition, a signal voltage of a signal processed by the respective circuit units of RF SoC 101 of FIG. 4 and a load capacity driven by the respective circuit units are shown in Table 1.

TABLE 1

| | | Analog | Digital circuit unit | |
|---|---|---|---|---|
| | RF circuit | circuit unit | 204, Memory | IF circuit unit |
| | unit 202 | 203 | circuit unit 205 | 201 |
| Signal | A few μV | A few mV | ~1 V | 2.5~5 V |
| voltage | | | | |
| Driving | <100 fF | <1 pF | ~a few pF | A few~10 pF |
| capacity | | | | |

As is apparent from Table 1, since RF circuit unit 202 processes a low power signal of a few μV, if noise of a few μV penetrates from another circuit unit, it cannot perform normal transmission and reception. Moreover, IF circuit unit 201 that drives large capacity load (a few to 10 pF) at the largest voltage (2.5 to 5 V) may be the source for generating the largest noise. Therefore, between the internal circuits of RF SoC 101, in a case where RF circuit unit 202 transmits and receives a signal, first of all, an operation of IF circuit unit 201 is stopped, and after an operation of RF circuit unit 202 is stopped, the operation of IF circuit unit 201 is resumed to exchange signals with a peripheral apparatus on the outside of RF SoC 101. It is thus possible to fundamentally eliminate noise applied from IF circuit unit 201 to RF circuit unit 202. Here, it is necessary to preserve a transmitted and received signal in a buffer in RF SoC 101 until the operation of RF circuit unit 202 is stopped. Further, the signal voltage of the signal processed by analog circuit unit 203 is a few my, and the load capacity thereof is smaller than 1 pF. Furthermore, the signal voltage of the signal processed by digital circuit unit 204 is about 1 V, and the load capacity thereof is smaller than a few pF.

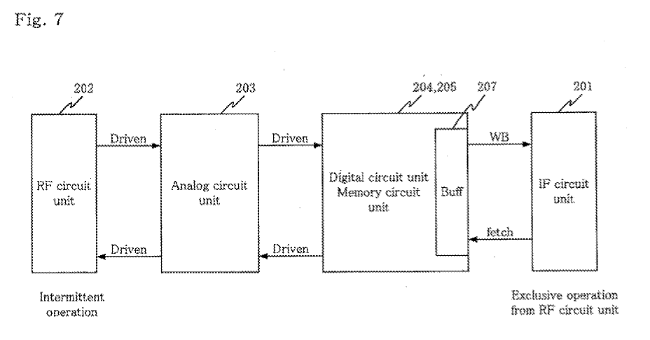

FIG. 7 is a diagram illustrating a construction of RF SoC 101 in which a buffer that preserves a transmitted and received signal is arranged.

As illustrated in FIG. 7, Buff 207, which is the buffer that preserves the transmitted and received signal, is arranged in digital circuit unit 204 or memory circuit unit 205.

In the meantime, the above explanation is associated with a case where a major cause of noise applied to RF circuit unit 202 is the operation of IF circuit unit 201. On the other hand, when noise that is the same as that of IF circuit unit 201 is generated from digital circuit unit 204 or memory circuit unit 205, information digitalized in analog circuit unit 203 may be preserved in Buff 207, and RF circuit unit 202, digital circuit unit 204, memory circuit unit 205 and IF circuit unit 201 may operate in a time-exclusive way.

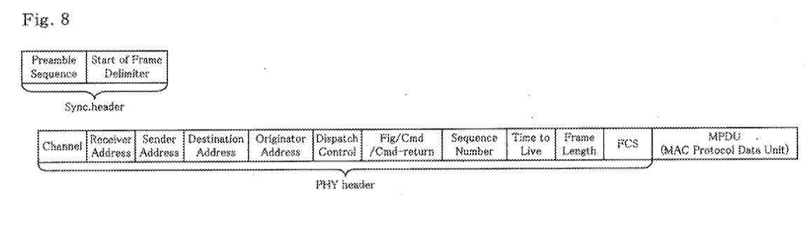

FIG. 8 is a diagram illustrating a communication protocol used generally in wireless communication.

In a receiving operation of RF SoC 101, Sync. header information and PHY header information which are header information of the protocol of FIG. 8 are received, and RF circuit unit 202, analog circuit unit 203, digital circuit unit 204 and memory circuit unit 205 of FIG. 7 are operated to confirm whether a receiver address is identical to the own node address, whether a sender address is an authenticated address, and whether received data are identical to a Frame Check Sequence (FCS) value. At this point of time, an operation of IF circuit unit 201 is stopped, and a MAC Protocol Data Unit (MPDU) is recorded on Buff 207. After all MPDU data are recorded on Buff 207, the operation of IF circuit unit 201 is resumed. Meanwhile, in a transmitting operation, in the example of sensor network node 100 of FIG. 3, a transmitted signal is received from MCU 105, an operation of RF circuit unit 202 is stopped, and all transmission protocols from an external apparatus are recorded on Buff 207. Next, digital circuit unit 204 and memory circuit unit 205 are operated to confirm whether the Sync. header and the PHY header have been appropriately prepared. Thereafter, analog circuit unit 203 and RF circuit unit 202 are operated to transmit the protocol. In the meantime, when the Sync. header and the PHY header have not been appropriately prepared (e.g. when the sender address is not the own node address, etc.), the protocol is not transmitted, an error is sent back to MCU 105, and transmission protocol data are awaited again.

As a result of this processing, RF circuit unit 202 and IF circuit unit 201 never operate at the same time, and noise is prevented from infiltrating from IF circuit unit 201 to RF circuit unit 202, disturbing transmitted and received data.

Here, only the exclusive operations of RF circuit unit 202 and IF circuit unit 201 have been explained for simplification of explanation. However, a transmitting and receiving method that operates RF circuit unit 202, digital circuit unit 204, memory circuit unit 205 and IF circuit unit 201 in an exclusive way may be used.

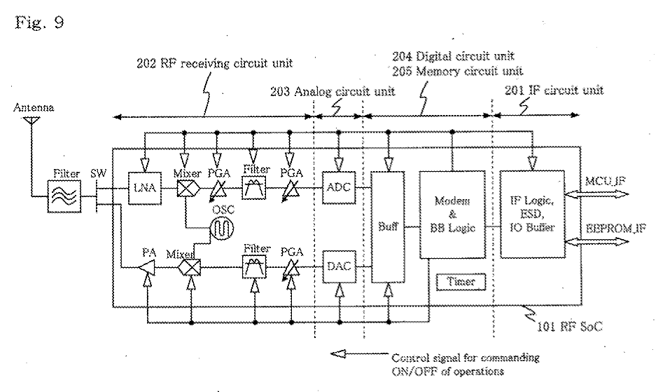

FIG. 9 is a view illustrating a new detailed circuit construction of RF SoC 101 of FIG. 4.

As illustrated in FIG. 9, in this circuit construction, Buff is arranged between a circuit unit where digital circuit unit 204 and memory circuit unit 205 are integrated, and analog circuit unit 203. In a receiving operation, when the circuit unit where digital circuit unit 204 and memory circuit unit 205 are integrated, judges that a Sync. header and a PHY header are appropriate, operation of IF circuit unit 201 is stopped at once, and Buff preserves MPDU data.

Thereafter, a control signal for commanding ON/OFF of operations of the respective circuit units is generated from the circuit unit where digital circuit unit 204 and memory circuit unit 205 are integrated. Meanwhile, when an operation of IF circuit unit 201 is ON/OFF using any receiving or transmitting operation as a trigger, it is necessary to generate a control signal from an LNA circuit unit that is a low noise amplifier and a PA circuit unit that is a power amplifier of FIG. 9. Such a control signal can be easily generated and transferred to each circuit unit via internal wiring of RF SoC 101.

The semiconductor device so constructed is used in an environment monitoring system.

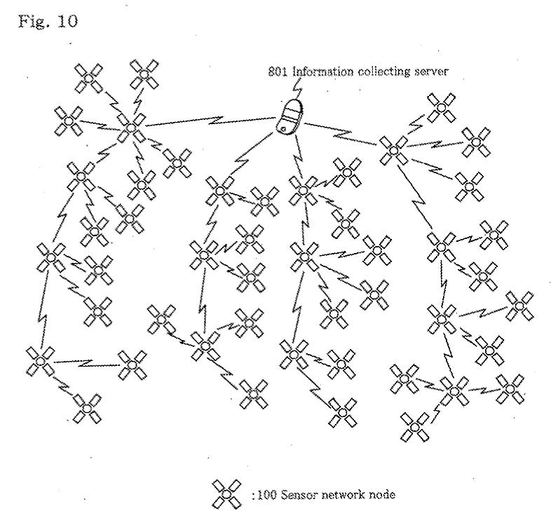

FIG. 10 is a view illustrating a configuration of a wireless communication sensor network system using sensor network node 100 of FIG. 3.

In the wireless communication sensor network system using sensor network node 100 of FIG. 3, as illustrated in FIG. 10, a plurality of sensor network nodes 100 are connected to information collecting server 801 that collects information acquired by sensor network node 100. An ambient temperature and humidity are measured by a sensor arranged in each sensor network node 100, and measured information is transferred to information collecting server 801 via multi-hop communication between sensor network nodes 100. Although not realizing RF SoC implementation of a wireless circuit, that is low cost and enables low power consumption, an example of the wireless communication sensor network system for environment monitoring has been concretely explained in ‘Development of wireless communication sensor network system and its application expansion to environment monitoring’, NEC technical journal, Vol. 57, No. 1/2004, pp 54).

As set forth herein, the present invention is to provide a circuit operating method that can operate an RF SoC at a low cost and that enables low power consumption, which is a core device of an intermittently operating wire communication network node represented as the wireless communication sensor network system of FIG. 10. Application examples of the wireless transmitting and receiving method of the present invention are a security system using a monitoring camera network that can be freely powered by a small battery for a few years without needing maintenance, an entrance and leaving checking system, and a widely-used wireless communication system for logistics management, patient management in the medical care spot, etc.

As discussed earlier, according to the present invention, the operation of the RF circuit that processes a low amplitude and low power signal of a few μV and the operation of the external IF circuit that drives load of a few to a few tens pF with a large signal amplitude of a few V are performed in a time-divided manner. Therefore, the present invention does not increase chip cost and power consumption By using the physical separation region, and enables reception of a wireless electric wave at a high S/N ratio. In this case, the wireless receiving circuit unit cannot perform a regular (continuous) operation. However, an intermittent operation of wireless communication is enough for many ubiquitous wireless systems. Particularly, a system that transmits a small quantity of data once for a few minutes to a few days, which is represented as a sensor network, does not require regular operation of the wireless transmitting and receiving circuit. In the case of an RFID which is recently commercialized, although a wireless communication device is attached to every article to manage the attributes of each article, wireless communication is performed at an extremely low frequency. The RF SoC device of the present invention, which is a high function RFID device with a transmitting and receiving function, has a function suitable to replace a current RFID device. Since the wireless communication device requires lower cost and lower power consumption than the regular operation of wireless communication, the operating method of the RF SoC device of the present invention is superior.

In addition, since the present invention does not use the circuit operation separation that uses a high resistance large capacity, it is possible to completely restrict noise interference through Vcom that is a common potential between the circuit blocks or a GND level. Accordingly, it is not necessary to constrain functional macro blocks used in the RF SoC, and it is possible to use IP macros sold at a market, which enormously improves flexibility of mountable functions.

As described above, the semiconductor device of the present invention may stop an operation of the external interface unit, when the wireless transmitting and receiving unit receives header information of a wirelesS signal.

In addition, the semiconductor device of the present invention may include a digital circuit unit that generates a signal for controlling operations of the wireless transmitting and receiving unit and the external interface unit.

Moreover, the wireless transmitting and receiving unit may generate a signal for controlling operations of the wireless transmitting and receiving unit and the external interface unit.

While the present invention has been described in connection with the exemplary embodiments, the present invention is not limited thereto. Therefore, it will be understood by those skilled in the art that various modifications and changes can be made to the construction or details of the present invention within the scope of the present invention.

This application claims priority based on Japanese Patent Application No. 2007-070580 filed on Mar. 19, 2007, the entire contents of which are incorporated herein by reference.

1. A semiconductor device for performing wireless communication, comprising:
a wireless transmitting and receiving unit that transmits and receives a wireless signal; and
an external interface unit that transmits and receives a signal to and from an external apparatus connected to the semiconductor device at a signal voltage larger than that of the wireless signal transmitted and received by the wireless transmitting and receiving unit,
wherein the wireless transmitting and receiving unit and the external interface unit mutually operate in a time-exclusive way.

2. The semiconductor device of claim 1, which stops an operation of the external interface unit, when the wireless transmitting and receiving unit receives header information of the wireless signal.

3. The semiconductor device of either claim 1, comprising a digital circuit unit that generates a signal for controlling operations of the wireless transmitting and receiving unit and the external interface unit.

4. The semiconductor device of either claim 1, wherein the wireless transmitting and receiving unit generates a signal for controlling operations of the wireless transmitting and receiving unit and the external interface unit.

5. A signal processing method of a semiconductor device including a wireless transmitting and receiving unit that transmits and receives a wireless signal, and an external interface unit that transmits and receives a signal at a signal voltage larger than that of the wireless signal transmitted and received by the wireless transmitting and receiving unit,
the method comprising controlling an operation of the wireless transmitting and receiving unit and an operation of the external interface unit in a time-exclusive way.
